(19) United States
(12) Patent Application Publication
(10) Pub. No.: US 2021/0275947 A1
(43) Pub. Date: Sep. 9, 2021

(54) Solid Phase Extraction Disk and Manufacturing Method

(71) Applicant: Kevin Charles Dinnean, Webster, NH (US)

(72) Inventor: Kevin Charles Dinnean, Webster, NH (US)

(21) Appl. No.: 17/192,932

(22) Filed: Mar. 5, 2021

Related U.S. Application Data
(60) Provisional application No. 62/986,680, filed on Mar. 7, 2020.

(51) Int. Cl. B01D 39/20; G01N 1/40; B01D 29/01

(52) U.S. Cl. CPC B01D 39/2017; G01N 1/4077; B01D 29/01; B01D 2239/10; B01D 2239/0407; B01D 2239/065; G01N 2001/4088

(57) ABSTRACT

Solid phase extraction (SPE) disks are manufactured by introducing a series of components and/or liquid suspensions into a mold and evacuating the liquid to form a cohesive filter or SPE disk. After all the free liquid has been substantially removed, the SPE disk is removed from the mold and dried. SPE disks are for use in analytical chemistry procedures.

### CROSS REFERENCE TO RELATED APPLICATIONS

Provisional Application No. 62/986,680, filed on Mar. 7, 2020

### STATEMENT OF FEDERALLY SPONSORED RESEARCH

Not Applicable

### STATEMENT OF JOINT RESEARCH AGREEMENT

Not Applicable

### SEQUENCE LISTING

Not Applicable

### BACKGROUND

Relevant Prior Art

| Patent Number | Kind | Issue Date | Patentee |
|---|---|---|---|
| U.S. Pat. No. 8,528,747 | B2 | Sep. 10, 2013 | Dinnean et al. |

The art of solid phase extraction (SPE) involves removing minor chemical constituents from a sample of water or other liquid. This is generally done for two purposes. The first of these two purposes for employing solid phase extraction is to capture the method analytes (the chemicals a given SPE procedure seeks to isolate) on the SPE disk for the purpose of identifying the specific chemicals present and determining their concentration in the original water or other liquid sample. The second of these two purposes is to remove or isolate the chemical constituents that are not analytes of the testing procedure being employed. These chemical constituents are removed because they can interfere with the accurate identification or quantification of the method analytes. The chemical identity and concentration of the chemical constituents removed as interferents by the solid phase extraction process are not determined. It is possible for a procedure to employ both processes described. An SPE procedure is usually followed by a determinative technique to identify the specific chemical identity and concentration of the method analytes. These determinative techniques include gas chromatography, liquid chromatography, mass spectrometry, and optical (or light absorption) techniques.

The SPE disks described in this invention are filters used to remove chemicals from liquids as part of a solid phase extraction procedure. These SPE disks contain one or more sorbents embedded in a glass fiber matrix. This glass fiber matrix forms the structure of the SPE disk. Sorbents may consist of particles of silica with or without surface modifications, or particles of polymeric material that have hydrophobic, hydrophilic or ion exchange functionality. Both the sorbent particles and the glass fiber matrix adsorb chemical constituents (analytes and interferents) from liquid samples passed through the SPE disk.

A filtration apparatus is employed to filter the sample through the solid phase extraction (SPE) disk. The filtration device may consist of a bottom piece on which the SPE disk rests and a funnel, or reservoir, that attaches to the bottom piece while also securing the SPE disk in place. The bottom piece needs to incorporate a mesh, screen or other type of permeable member to allow liquids to pass through the disk, generally aided by vacuum, in a uniform manner. A means to collect the liquids that pass through the disk is also necessary. A variety of filtration apparatuses are available, from simple manually operated systems to complex automated systems.

A solid phase extraction disk, after installation in a filtration device, may first be rinsed with a suitable solvent to remove impurities that may be present in the SPE disk with the solvent being removed from the SPE disk, under vacuum (or forced through the SPE disk under positive pressure). This solvent is collected and usually discarded. Phthalates, a common chemical used to impart flexibility in certain plastics is often an impurity present in laboratory consumables such as SPE disks. Impurities in the SPE disk, if not removed, may interfere in the analytical test being conducted or result in inaccurate results.

Certain SPE disks need to be preconditioned in order to function properly. An example of an SPE procedure using an SPE disk requiring preconditioning would be a procedure employing an SPE disk containing a C-18 sorbent being used to test drinking water for chemical contaminants. C-18 sorbent consists of particles of silica or polymer with an octadecyl surface modification imparting hydrophobic properties. If using a C-18 disk, after any rinsing with solvent to remove impurities as previously described, the SPE disk is rinsed with methyl alcohol to precondition the C-18 sorbent. The methyl alcohol is partially pulled through the SPE disk displacing any prior rinse solvents but is not completely pulled through the disk exposing the C-18 sorbent to air. After this conditioning with methyl alcohol, the SPE disk must remain immersed in methyl alcohol or water until the sample filtration step is complete. Next, water is added to the reservoir diluting the methyl alcohol covering the top of the disk. The water is partially pulled through the disk, substantially displacing the methyl alcohol but again leaving a layer of water on top of the disk to avoid exposing the C-18 sorbent to air. Next, the water sample undergoing analysis is added to the reservoir and vacuum applied under the disk to facilitate filtering the water sample through the SPE disk. As the water sample passes through the SPE disk, chemicals such as pesticides or herbicides, present in the water sample are retained by adsorption onto the C-18 sorbent or adsorption onto the glass fiber structural material of the SPE disk. After the filtration of the water sample is complete, air is passed through the disk, aided by the continued application of vacuum, for a short time to remove residual water.

If it is desired to first remove impurities that may have been retained by the SPE disk that could interfere with the identification and quantification of method analytes using the intended determinative technique, then the following procedures are employed. A suitable rinse solution such as an aqueous salt solution or a polar organic solvent would be added to the reservoir. An organic solvent, if used, would need to be a polar solvent as a strongly non-polar organic solvent would not mix with or displace the residual water left in the disk. The non-polar organic solvent may also fail to pass through the disk under vacuum due to the immiscibility of water and the strongly non-polar organic solvent. Care must be exercised in choosing a rinse solvent as the rinse solvent must remove the impurities without removing the analytes filtered out of the original water sample. This rinse solvent is normally discarded.

The next step is to transfer the analytes removed from the water sample by the SPE disk to a suitable solvent. This step is necessary prior to conducting a determinative analysis to identify the chemical composition and concentration of the analytes that were present in the original water sample.

First, a small volume of a polar organic solvent, such as acetone or ethyl acetate, is added to the reservoir and soaks through the disk. This polar elution solvent serves two purposes: it helps remove any remaining water, and it begins the process of transferring the chemicals removed from the original water sample to organic solvent. This first solvent rinse, or elution solvent, is removed under vacuum and collected in a clean container. This may be followed by adding a small volume of a non-polar solvent to the reservoir as necessary to remove certain hydrophobic analytes that are more strongly retained by the SPE disk. This solvent is also removed under vacuum and collected, usually in the same container as the first polar elution solvent. This step may be repeated several times as necessary depending on the specific procedure being employed. When the necessary or proscribed elution procedure has been completed, it is often necessary to remove any water from this collected elution solvent (or extract) before proceeding. This can be done by passing the solvent extract through an anhydrous salt such as sodium sulfate.

This dried solvent extract can undergo a variety of determinative techniques to identify and determine the concentration of the analytes present in the solvent extract. These determinative techniques include gas chromatography, liquid chromatography, mass spectrometry, and optical (or light absorption) techniques. This information from the determinative technique on the concentration of analytes in the extract can be used to calculate the concentration of the analytes in the original water sample. These calculations would also require the volume of the original water sample and the final volume of the solvent extract, both of which should be determined. The extract may also be partially evaporated from a volume of, for example, 20 mL to a volume of 0.5 mL prior to analysis by the determinative technique, provided the extract solvents are sufficiently volatile. In this example, a 40-fold reduction in volume would increase the concentration of analytes in the extract by up to 40 times. This increase in the concentration of analytes in the extract results in the determinative technique being able to detect the method analytes at a 40-fold lower concentration. Method analytes may be partially lost during the evaporation step if the boiling points of the extract solvents are not significantly lower than the boiling point of a given method analyte. Alternately, if the method analytes are sufficiently non-volatile, the extract may be evaporated to dryness and reconstituted in a solvent appropriate for the intended determinative technique. It is also possible to evaporate the solvent to dryness and determine the concentration of material extracted from the original water sample by weighing the residue left after the evaporation is complete. This weighing, or gravimetric technique, does not identify the specific chemicals that were present in the original water sample.

### SUMMARY

The solid phase extraction disks of this invention are layered with a glass fiber layer or layers on the bottom, a glass fiber and sorbent layer in the middle, and a glass fiber layer on top. The bottom glass fiber layer may consist of wet-laid glass fiber or a piece of glass fiber mesh or filter paper which is placed into the disk-forming mold prior to the introduction of the first liquid suspension. The wet-laid layers of the SPE disk are formed by adding a series of liquid suspensions to the disk-firming mold and evacuating the liquid in a process analogous to making paper. These suspensions may consist of glass fiber in water, or glass fiber and one or more sorbents in a water and alcohol mixture. The glass fiber present in the glass fiber and sorbent layer serves two purposes. First, it keeps the sorbent uniformly suspended in an aqueous solution prior to introduction of the suspension into the disk-forming mold during SPE disk manufacture. Otherwise, the sorbent would fall to the bottom of the container. Second, it adheres the glass fiber and sorbent layer to the glass fiber layers above and below it. Without glass fiber in the glass fiber and sorbent layer, the SPE disk would fall apart after it was dry.

A disk-forming mold is used to form the SPE disks and contain the liquid suspensions. At the base of the disk-forming mold is a screen or other permeable member on which the SPE disk forms. Vacuum is applied below the screen to remove liquids from the various aqueous suspensions introduced into the mold. A means to apply vacuum and collect the liquids removed during SPE disk manufacture is necessary. A means, such as a measuring cup, can be used to add an aliquot of the various suspensions to the disk-forming mold.

### BRIEF DESCRIPTION OF FIGURES

FIG. 1: Shows an exterior perspective view of a solid phase extraction (SPE) disk.

FIG. 2: Shows a cross section of a first example of an SPE disk constructed using a manufacturing method that is the subject of this patent.

FIG. 3: Shows a cross section of a second example of an SPE disk constructed using a manufacturing method that is the subject of this patent.

FIG. 4: Shows a cross section of a third example of an SPE disk constructed using a manufacturing method that is the subject of this patent.

FIG. 5: Shows the tools and fixtures used to fabricate SPE disks using the manufacturing methods described in this patent.

FIG. 6: Shows a cross section of the disk-forming mold, screen, vacuum port and associated parts.

FIG. 7: Shows a top view of the disk-forming mold.

### LIST OF REFERENCE NUMERALS

10 SPE disk
11 SPE disk bottom circular surface
12 SPE disk edge or side cylindrical surface
14 SPE disk top circular surface
20 Top cylindrical layer of wet-laid glass fiber on SPE disk
22 Cylindrical sorbent and glass fiber layer of SPE disk containing wet-laid glass fiber and a sorbent or sorbents
24 Piece of glass fiber mesh or filter paper that can form the bottom circular surface of the SPE disk (the same numeral is used to refer to the glass fiber mesh or filter paper both as a raw material and as a component of a finished SPE disk)
30 Cylindrical wet-laid glass fiber layer below the glass fiber and sorbent layer and above the glass fiber mesh or filter paper
40 Cylindrical wet-laid glass fiber layer below the glass fiber and sorbent layer forming the bottom circular surface of the SPE disk
50 Screen or other porous material
51 Disk-forming mold
52 Outlet of disk-forming mold through which liquid is drained
53 Gasket to establish seal between disk-forming mold and vacuum port
54 Passageway through vacuum manifold and port for applying vacuum below the screen at the base of the disk-forming mold
55 Vacuum port on vacuum manifold
56 Vacuum manifold
58 Disk edge compressing tool
59 Cavity in disk-forming mold
70 Base of disk-forming mold
72 Aspiration grooves in base of disk-forming mold

### DETAILED DESCRIPTION

### Detailed Description of Figures

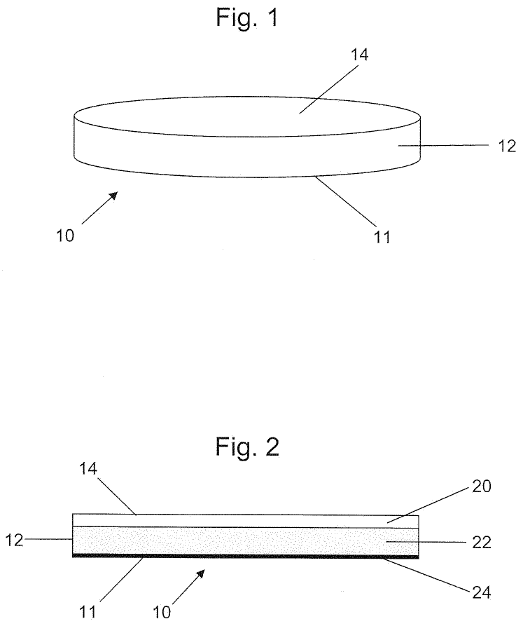

FIG. 1 Shows a perspective view of SPE disk 10 with bottom circular surface 11, cylindrical edge or side 12 and top circular surface 14.

FIG. 2 Shows a cross section of a first example of SPE Disk 10 constructed of glass fiber mesh or filter paper 24, wet-laid glass fiber and sorbent(s). Filter paper 24 forms bottom circular surface 11. Wet-laid glass fiber and sorbent layer 22 is formed on top of, and adhered to, filter paper 24. Wet-laid glass fiber layer 20 is formed on top of, and adhered to, glass fiber and sorbent layer 22. Glass fiber layer 20 forms top circular surface 14 of SPE disk 10. Side 12 is formed from the edge of filter paper 24 and the cylindrical surfaces of glass fiber and sorbent layer 22 and glass fiber layer 20.

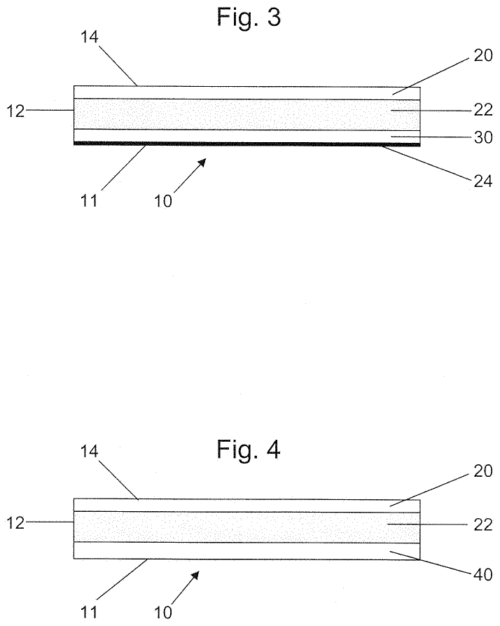

FIG. 3 Shows a cross section of a second example of SPE Disk 10 constructed of glass fiber mesh or filter paper 24, wet-laid glass fiber and sorbent(s). Filter paper 24 forms bottom circular surface 11. Wet-laid glass fiber and sorbent layer 30 is formed on top of, and adhered to, filter paper 24. Glass fiber and sorbent layer 22 is formed on top of, and adhered to, glass fiber layer 30. Wet-laid glass fiber layer 20 is formed on top of, and adhered to, glass fiber and sorbent layer 22. Wet-laid glass fiber layer 20 forms top circular surface 14 of SPE disk 10. Side 12 is formed from the edge of filter paper 24 and the cylindrical surfaces of glass fiber layer 30, glass fiber and sorbent layer 22 and glass fiber layer 20.

FIG. 4 Shows a cross section of a third example of SPE Disk 10 constructed of wet-laid glass fiber and sorbent(s). Wet-laid glass fiber and sorbent layer 40 forms bottom circular surface 11. Glass fiber and sorbent layer 22 is formed on top of, and adhered to, glass fiber layer 40. Wet-laid glass fiber layer 20 is formed on top of, and adhered to, glass fiber and sorbent layer 22. Wet-laid glass fiber layer 20 forms top circular surface 14 of SPE disk 10. Side 12 is formed from the cylindrical surfaces of glass fiber layer 40, glass fiber and sorbent layer 22 and glass fiber layer 20.

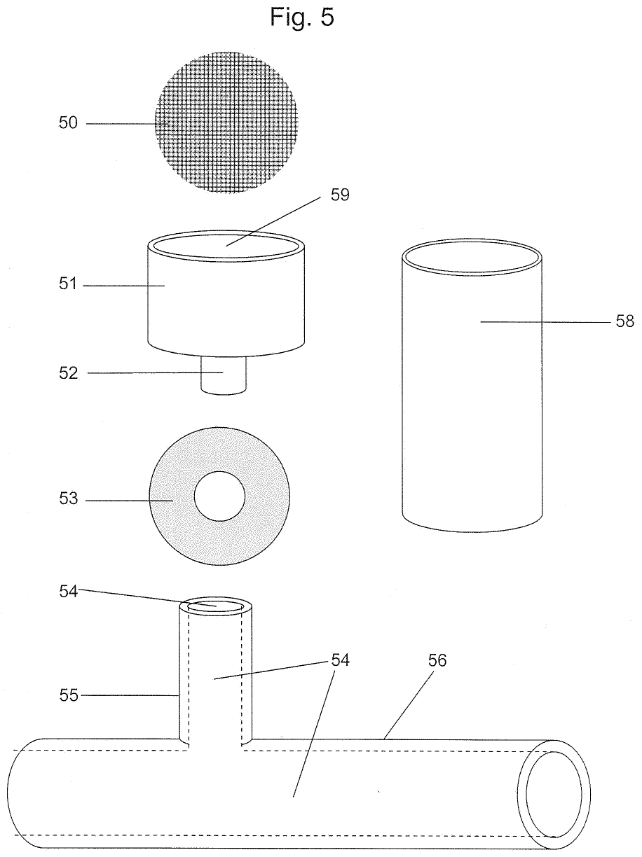

FIG. 5 Shows the tools used to form SPE disk 10. Screen or other porous material 50 sits in, or is part of, base 70 of disk-forming mold 51. Disk-forming mold 51 has outlet 52 through which liquid is removed during fabrication of SPE disk 10. Outlet 52 extends through the hole in gasket 53 and into passageway 54 of vacuum port 55. Gasket 53 establishes a seal between outlet 52 of disk-forming mold 51 and vacuum port 55. Vacuum is applied to vacuum port 55 by a vacuum source attached to vacuum manifold 56. Disk-forming mold 51 has cavity 59 into which glass fiber filter paper 24 may be placed and into which the glass fiber suspension and the glass fiber and sorbent suspension are introduced. Disk edge compressing tool 58 is a hollow cylinder, preferentially made out of metal, with a thin wall (approximately 1 mm) that fits snugly into cavity 59 of disk-forming mold 51. Disk edge compressing tool 58 is inserted into cavity 59 of disk-forming mold 51 and used to compress edge or side 12 on SPE disk 10.

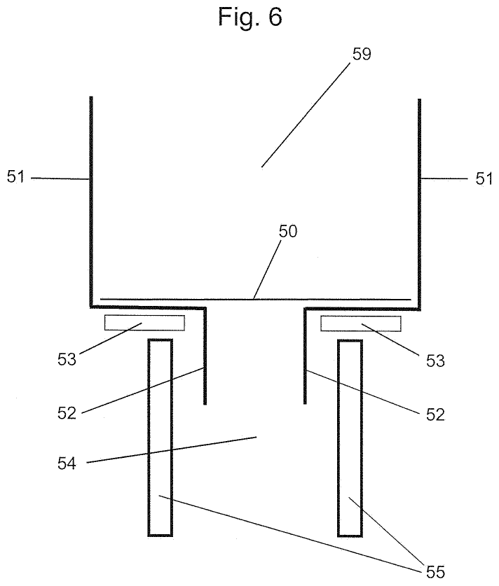

FIG. 6 Shows a cross section of disk-forming mold 51, screen or other porous material 50, outlet 52, gasket 53, passageway 54, vacuum port 55 and cavity 59.

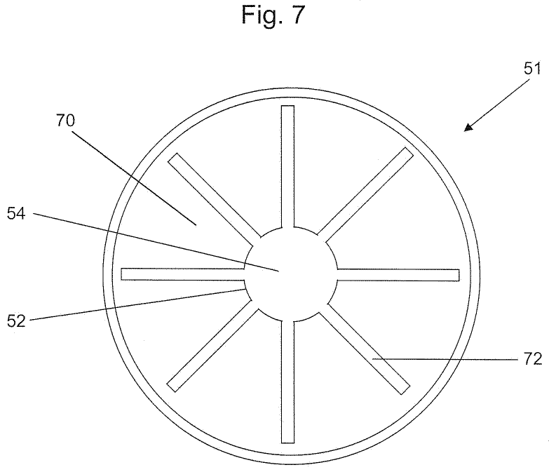

FIG. 7 Shows the top view of disk-forming mold 51 with outlet 52, passageway 54, base 70 and aspiration grooves 72. Aspiration grooves 72 in base 70 aids in distributing vacuum under screen 50 during the formation of SPE disk 10.

### Advantages

The improved SPE disk 10 of this invention encapsulates the particulate sorbent present in glass fiber and sorbent layer 22 in a glass fiber matrix. This encapsulation limits the shedding of sorbent particles from finished SPE disk 10. The particulate sorbent is not fully encapsulated as sorbent layer 22 extends to edge or side 12 of SPE disk 10. The sorbent exposed on side 12 of SPE disk 10 is limited from shedding by the compression of edge or side 12 by disk edge compressing tool 58 during SPE disk 10 manufacture. Sorbent particles, when shed from SPE disk 10, can interfere with the operation of, or damage, valves present on many automated and manually operated SPE disk extraction apparatuses. This encapsulation of the sorbent particles is accomplished using a less complex manufacturing process than prior art. This less complex manufacturing process also generates less waste. Top glass fiber layer 20 prevents shedding of sorbent particles, and when in use in an SPE disk extraction procedure, glass fiber layer 20 can retain some very non-polar method analytes or interfering compounds. These very non-polar analytes or interfering compounds, if not adsorbed by the glass fiber present in top glass fiber layer 20, would be adsorbed by glass fiber and sorbent layer 22; which in the absence of top glass fiber layer 20 would form top circular surface 14 of SPE disk 10. The sorbent in glass fiber and sorbent layer 22 has a finite capacity to adsorb analytes, and by retaining some very non-polar analytes or interfering compounds on top glass fiber layer 20, the capacity of the sorbent in glass fiber and sorbent layer 22, to retain polar and moderately non-polar method analytes is increased. The improved SPE disk 10 of this invention also has the sorbent distributed uniformly, not located in a central section of the SPE disk, as found in some prior art. Locating the sorbent in a central section of the SPE disk, surrounded by a ring of glass fiber not containing sorbent, as found in some prior art, mandates a larger diameter SPE disk. SPE disk 10 of this invention can be used with existing SPE disk extraction apparatuses which were designed to work with a 47 mm diameter SPE disk, many of which are not compatible with a 50 mm diameter SPE disk, as found in some prior art.

### Operation

The tools used to manufacture SPE 10 should be free from chemical contamination which could be detrimental to the end use of SPE disk 10 in analytical chemistry procedures. A suitable vacuum (or positive pressure) source and a means to collect the water and water/alcohol mixtures generated by the manufacturing process are necessary.

Glass fiber mesh or filter paper 24 is glass microfiber filter paper which is typically and preferentially made of binderless borosilicate glass fiber. Filter paper 24 may or may not contain boron or organic binders. Filter paper 24 is typically, but not necessarily, circular and typically 0.3 mm to 0.6 mm thick, although thinner or thicker filter paper 24 may also be suitable. Examples of suitable filter paper 24 include Whatman™ Part Number 1820-047 (47 mm diameter).

A suspension of glass fibers in water is used to form wet-laid glass fiber layers 20, 30 and 40 and wet-laid glass fiber and sorbent(s) layer 22. This suspension can be prepared from bulk glass fiber such as CM 210-04-F glass fiber from Lauscha Fiber International. This glass fiber is supplied in bales, not loose glass fibers, although glass fiber supplied as loose fibers may be suitable.

To prepare the glass fiber suspension, 4,500 mL of distilled, deionized, reverse osmosis or other suitable water is added to a suitable container such as a 18,927 mL plastic pail. The water may be, and is preferentially, acidified to a pH between 2.0 and 2.2 with hydrochloric, or other suitable acid. Next 20 grams of CM 210-04-F glass fiber is added to the acidified water. The glass fiber is then dispersed using a hand-held blender such as a Mueller Ultra Stick Hand Blender or other similar means. Some manipulation of the Mueller blender is necessary initially to break up the glass fiber but after 15 seconds, it should be possible to position the Mueller blender, with the guard around the cutting blade resting on the bottom of the 18,927 mL pail, about half way between the center and side of the 18,927 mL plastic pail, and have the suspension circulate by the action of the Mueller blender. Two minutes of total blending time is necessary. This glass fiber suspension may be prepared in larger quantities by using a more powerful blender and increasing the quantities of pH 2.0 to 2.2 water and glass fiber accordingly. Note that care must be exercised throughout this process to avoid introducing plasticizers or other impurities into the disk ingredients or finished SPE disk 10 as these impurities are detrimental to the use of SPE disk 10 for analytical chemistry purposes.

The next step is to prepare the glass fiber and sorbent suspension used to form glass fiber and sorbent layer 22 of SPE disk 10 as shown in FIGS. 2, 3 and 4. First, weigh an appropriate amount of sorbent or sorbents into a clean container such as a beaker. More than one type of sorbent may be used. Dividing the weight of the sorbent used by the number of SPE disk(s) 10 to be produced will yield the sorbent mass per disk. Examples of sorbent include divinylbenzene polymers (DVB) which may be further modified with hydrophilic, anion or cation exchange capability, and silica, which can have its surface modified a number of ways including with bonded octadecyl (C-18) or octyl (C-8) functionality. Sorbent is supplied as a fine powder or particles. Typical particle sizes for sorbents are 5 um to 80 um although sorbents may have smaller or larger particle sizes.

Next, add isopropyl alcohol to the beaker in a quantity sufficient to cover and saturate the sorbent and mix the sorbent in the isopropyl alcohol. Other alcohols or polar solvents may also be suitable. This is done as a hydrophobic sorbent may not otherwise disperse in the aqueous glass fiber suspension. Next, add the previously prepared glass fiber suspension in a quantity sufficient to bring the sorbent and alcohol mixture up to the desired volume and mix thoroughly. The resulting suspension is the glass fiber and sorbent suspension used to form glass fiber and sorbent layer 22. If low masses of sorbent are used (less than 250 mg of polymeric sorbent for a 47 mm disk for example), it may be possible to bring the sorbent and alcohol mixture up to the desired volume with equal amounts of glass fiber suspension and pH 2.0 to 2.2 water. This results in less glass fiber being present in glass fiber and sorbent layer 22 and results in a thinner SPE disk 10. A thinner SPE disk 10 is desirable, as when used to conduct an SPE extraction, less solvent is necessary for the solvent rinse and solvent elution steps, and less water, which must be removed from the solvent extract, is retained by SPE disk 10 at the end of the sample filtration step.

Once the glass fiber and sorbent suspension has been prepared, the disk can be made in the following steps. Assemble all the tools shown in FIG. 5 and attach vacuum manifold 56 to a suitable vacuum supply. A means to collect the liquids drained through vacuum manifold 56 will also need to be provided. Measuring cups are needed, the size of the necessary measuring cups depends on the specific SPE disk 10 being manufactured. The measuring cups are used to add aliquots of the glass fiber suspension and the glass fiber and sorbent suspension into cavity 59 of disk-forming mold 51. A suitable means to add pH 2.0 to pH 2.2 water into cavity 59 of disk-forming mold 51 should also be provided. SPE disk 10 is manufactured by introducing a series of components and/or suspensions into cavity 59 of disk-forming mold 51. Screen 50 is placed into cavity 59 of disk-forming mold 51 and sits on base 70 above aspiration grooves 72 as shown in FIG. 6. Passageway 54 extends from under screen 50 along base 70, through aspiration grooves 72, outlet 52, port 55 and manifold 56. Vacuum is applied below screen 50 through passageway 54 to facilitate removal of liquids during manufacture of SPE disk 10. If glass fiber filter paper 24 is to form bottom circular surface 11 of SPE disk 10 it is placed into cavity 59 of disk-forming mold 51 and sits on top of screen 50. Filter paper 24 may next, and preferentially, be wetted with pH 2.0 to 2.2 water. Wetting glass fiber filter paper 24 after it has been inserted into cavity 59 reduces the flow of air through filter paper 24 when vacuum is applied resulting in greater vacuum under screen 50. This vacuum forces filter paper 24 against screen 50 and screen 50 is likewise forced onto base 70. This aids in disk manufacture by helping to prevent any of the first suspension added to cavity 59 of disk-forming mold 51 from migrating around the edge of filter paper 24. Alternately, a layer of wet-laid glass fiber may be used to form bottom circular surface 11 of SPE disk 10, shown as wet-laid glass fiber layer 40 in FIG. 4.

This is followed by the introduction of a series of glass fiber suspensions into cavity 59 of disk-forming mold 51. These suspensions may be composed of only glass fiber or be composed of glass fiber and one or more sorbents. A means, such as a measuring cup, can be used to add an aliquot of the various suspensions to the disk-forming mold. While it is possible, but less precise, to pour an aliquot of a suspension directly into the disk-forming mold from a container such as a beaker, this technique is less reproducible than using measuring cups and is not preferred.

Liquids are removed from suspensions under vacuum, forming SPE disk 10. Liquids from a first suspension must be removed before a second suspension is added. Likewise, liquids from a second suspension must be removed before a third suspension is added. After all the free liquid has been substantially removed from SPE disk 10, disk edge compressing tool 58 is inserted into cavity 59 and used to compress side 12 of SPE disk 10. Enough force should be applied to disk edge compressing tool 58 to leave an impression around the outer edge of top surface 14 but not so much force that top glass fiber layer 20 is damaged or torn. This aids in the structural integrity of finished SPE disk 10 and helps prevent particles of sorbent from being shed from side 12 of finished SPE disk 10. SPE disk 10 is then removed from disk-forming mold 51 and dried. The resultant SPE disk 10 when dry is cohesive and can be easily handled and used. SPE disk 10 may be any diameter but is typically between 25 mm to 100 mm in diameter and 2 mm to 7 mm in thickness although a thicker or thinner disk is possible.

### Example SPE Disk A

SPE disk 10 as depicted in FIG. 2 could be manufactured using a variety of different sorbents, thicknesses and diameters. One possible example is a 47 mm diameter disk manufactured with the following composition.

### Materials:

Glass fiber suspension

pH 2.0 to 2.2 water

Divinylbenzene (DVB) polymeric sorbent

Isopropyl alcohol

Glass fiber mesh or filter paper 24, 47 mm in diameter

### Composition of Glass Fiber and Sorbent Suspension:

9.6 g DVB polymeric sorbent

120 mL Isopropyl alcohol

1310 mL Glass fiber suspension

Yield: Twenty Four 400 mg DVB SPE disks

First, place screen 50 in disk-forming mold 51. It should lie flat on base 70. Place gasket 53 around outlet 52 so that when outlet 52 of disk-forming mold 51 is placed in vacuum port 55, gasket 53 creates a seal as shown in FIG. 6. Place glass fiber filter paper 24, which will form bottom circular surface 11 of SPE disk 10, on top of screen 50. Wet glass fiber filter paper 24 With pH 2.0 to 2.2 water. Apply vacuum (a valve is useful for controlling the vacuum). Add 60 mL of glass fiber and sorbent suspension to cavity 59 of disk-forming mold 51 forming glass fiber and sorbent layer 22. The liquid should pass through glass fiber filter paper 24 and screen 50 rapidly. Leaving the vacuum on add 30 mL of glass fiber suspension to cavity 59 of disk-forming mold 51 to form top glass fiber layer 20. After all the free liquid has been substantially removed, insert disk edge compressing tool 58 into cavity 59 of disk-forming mold 51 and apply pressure to compress side 12 of SPE disk 10. The vacuum can now be turned off and disk-forming mold 51 removed from vacuum port 55. Next, SPE disk 10 is removed from disk-forming mold 51 by inserting a dowel or similar tool into outlet 52 and pushing screen 50 and SPE disk 10 out of disk-forming mold 51. SPE disk 10 is then separated from screen 50 and placed on a clean flat surface and dried. If heat is used to dry SPE disk 10, care must be exercised not to exceed the temperature limit of the sorbent(s).

### Example SPE Disk B

SPE disk 10 as depicted in FIG. 3 could be manufactured using a variety of different sorbents, thicknesses and diameters. One possible example is a 47 mm diameter disk manufactured with the following composition.

### Materials:

Glass fiber suspension

pH 2.0 to 2.2 water

Divinylbenzene (DVB) polymeric sorbent

DVB sorbent modified to have cation exchange functionality

Isopropyl alcohol

Glass fiber mesh or filter paper 24, 47 mm in diameter

### Composition of Glass Fiber and Sorbent Suspension:

6.0 g DVB polymeric sorbent

6.0 g DVB polymeric sorbent modified to have cation exchange functionality

120 mL Isopropyl alcohol

1310 mL glass fiber suspension

Yield: Twenty Four 500 mg mixed mode SPE disks

First, place screen 50 in disk-forming mold 51. It should lie flat on base 70. Place gasket 53 around outlet 52 so that when outlet 52 of disk-forming mold 51 is placed in vacuum port 55, gasket 53 creates a seal as shown in FIG. 6. Place glass fiber filter paper 24, which will form bottom circular surface 11 of SPE disk 10, on top of screen 50. Wet glass fiber filter paper 24 with pH 2.0 to 2.2 water. Apply vacuum (a valve is useful for controlling the vacuum) and add 30 mL of glass fiber suspension to cavity 59 of disk-forming mold 51 to form glass fiber layer 30. Leaving the vacuum on, add 60 mL of glass fiber and sorbent suspension to cavity 59 of disk-forming mold 51 forming glass fiber and sorbent layer 22. The liquid should pass through glass fiber filter paper 24, glass fiber layer 30 and screen 50 rapidly. Still leaving the vacuum on, add 30 mL of glass fiber suspension to cavity 59 of disk-forming mold 51 to form top glass fiber layer 20. After all the free liquid has been substantially removed, insert disk edge compressing tool 58 into cavity 59 of disk-forming mold 51 and apply pressure to compress side 12 of SPE disk 10. The vacuum can now be turned off and disk-forming mold 51 removed from vacuum port 55. SPE disk 10 can be removed from disk-forming mold 51 by inserting a dowel or similar tool into outlet 52 and pushing screen 50 and SPE disk 10 out of disk-forming mold 51. SPE disk 10 is then separated from screen 50 and placed on a clean flat surface and dried. If heat is used to dry SPE disk 10, care must be exercised not to exceed the temperature limit of the sorbent(s).

### Example SPE Disk C

SPE disk 10 as depicted in FIG. 4 could be manufactured using a variety of different sorbents, thicknesses and diameters. One possible example is a 47 mm diameter disk manufactured with the following composition.

### Materials:

Glass Fiber Suspension

pH 2.0 to 2.2 water

Polymeric C-18 sorbent

Isopropyl Alcohol

### Composition of Glass Fiber and Sorbent Suspension:

4.8 g Polymeric C-18 sorbent

120 mL Isopropyl Alcohol

660 mL Glass Fiber Suspension

660 mL pH 2.0 to 2.2 water

Yield: Twenty Four 200 mg Polymeric C-18 disks

First, place screen 50 in disk-forming mold 51. It should lie flat on base 70. Place gasket 53 around outlet 52 so that when outlet 52 of disk-forming mold 51 is placed in vacuum port 55, gasket 53 creates a seal as shown in FIG. 6. Apply vacuum (a valve may be useful for controlling the vacuum). Add 60 mL of glass fiber suspension to cavity 59 of disk-forming mold 51 to form glass fiber layer 40. This wet-laid glass fiber layer 40 forms bottom circular surface 11 of SPE disk 10. Leaving the vacuum on, add 60 mL of glass fiber and sorbent suspension to cavity 59 of disk-forming mold 51 forming glass fiber and sorbent layer 22. The liquid should pass through glass fiber layer 40 and screen 50 rapidly. Still leaving the vacuum on, add 30 mL of glass fiber suspension to form top glass fiber layer 20. After all the free liquid has been substantially removed, insert disk edge compressing tool 58 into cavity 59 of disk-forming mold 51 and apply pressure to compress side 12 of SPE disk 10. The vacuum can now be turned off and disk-forming mold 51 removed from vacuum port 55. SPE disk 10 can be removed from disk-forming mold 51 by inserting a dowel or similar tool into outlet 52 and pushing screen 50 and SPE disk 10 out of disk-forming mold 51. SPE disk 10 is then separated from screen 50 and placed on a clean flat surface and dried. If heat is used to dry SPE disk 10, care must be exercised not to exceed the temperature limit of the sorbent(s).

What is claimed is:

1. A solid phase extraction disk comprising:
a. a top circular surface consisting of a cylindrical layer of wet-laid glass fiber; and
b. a middle cylindrical layer underlying the top glass fiber layer containing wet-laid glass fiber and one or more sorbents; and
c. a glass fiber mesh or filter paper underlying the glass fiber and sorbent layer creating a bottom circular surface; the three components forming a cohesive unit.

2. A solid phase extraction disk comprising:
a. a top circular surface consisting of a cylindrical layer of wet-laid glass fiber; and
b. a middle cylindrical layer underlying the top glass fiber layer containing wet-laid glass fiber and one or more sorbents; and
c. a cylindrical layer of wet-laid glass fiber underlying the glass fiber and sorbent layer; and
d. a glass fiber mesh or filter paper underlying the second glass fiber layer creating a bottom circular surface; the four components forming a cohesive unit.

3. A solid phase extraction disk comprising:
a. a top circular surface consisting of a cylindrical layer of wet-laid glass fiber; and
b. a middle cylindrical layer underlying the top glass fiber layer containing wet-laid glass fiber and one or more sorbents; and
c. a cylindrical layer of wet-laid glass fiber underlying the glass fiber and sorbent layer creating a bottom circular surface; the three components forming a cohesive unit.

4. The disk of claim 1 where the edge of the top circular surface and cylindrical side is compressed during manufacture.

5. The disk of claim 2 where the edge of the top circular surface and cylindrical side is compressed during manufacture.

6. The disk of claim 3 where the edge of the top circular surface and cylindrical side is compressed during manufacture.
